(19) United States
(12) Patent Application Publication
(10) Pub. No.: US 2013/0136060 A1
(43) Pub. Date: May 30, 2013

(54) METADATA BASED ID INTERPRETATION APPARATUS AND METHOD

(71) Applicant: Electronics and Telecommunications Research In, Daejeon (KR)

(72) Inventors: Young Hwan CHOI, Daejeon (KR); Jun Seob LEE, Daejeon (KR); Hyoung Jun KIM, Daejeon (KR)

(73) Assignee: Electronics and Telecommunications Research Institute, Daejeon (KR)

(21) Appl. No.: 13/687,367

(22) Filed: Nov. 28, 2012

(30) Foreign Application Priority Data
Nov. 29, 2011 (KR) 10-2011-0125699
Feb. 24, 2012 (KR) 10-2012-0019312

(51) Int. Cl. H04W 4/00

(52) U.S. Cl. CPC H04W 4/00
USPC 370/328

(57) ABSTRACT

Disclosed is a metadata based identifier (ID) interpretation apparatus and method for communication between two nodes present in heterogeneous networks having different ID systems. All of the IDs may be integrally managed using an application layer ID, and communication between nodes having different ID systems may be performed through ID interaction.

### CROSS-REFERENCE TO RELATED APPLICATIONS

This application claims the priority benefit of Korean Patent Application No. 10-2011-0125699, filed on Nov. 29, 2011, and Korean Patent Application No. 10-2012-0019312, filed on Feb. 24, 2012, in the Korean Intellectual Property Office, the disclosures of which are incorporated herein by reference.

### BACKGROUND

1. Field of the Invention

Embodiments of the present invention relate to a metadata based identifier (ID) interpretation apparatus and method for communication between two nodes present in heterogeneous networks having different identity systems.

2. Description of the Related Art

A current Transmission Control Protocol/Internet Protocol (TCP/IP) based network is based on an IP that is a unit network identifier (ID) and thus, may have many disadvantages such as a lack of address, constraints on address recycle, and the like. To overcome the above disadvantages, interest on development of a next generation network or feature Internet technology has been increased. Conceptual infrastructure technology closely related to the next generation network is just Internet of Thing (IoT). All of the objects that are installed with a communication function may have connectivity therebetween, and may transmit and receive information as necessary. However, that all of the objects are present in a network having the same characteristic may not be assumed.

Two nodes present in heterogeneous networks may have the same ID systems and may also have completely different ID systems. To enable communication between two nodes in such circumstance, there is a need for a method that may maintain the connectivity between two nodes and enables different ID systems to be interacted with each other.

A problem found when two nodes present in two networks having different ID systems communicate with each other in a current network, that is, the reason why the communication is impossible in a circumstance where ID systems cannot be interacted with each other is because IDs of destination nodes to communicate with are various and thus, there is no alternative method for communication with a node having a predetermined ID. Accordingly, there is a need for a technical method of interpreting an ID and performing communication even though only an application ID of a destination node is given.

### SUMMARY

An aspect of the present invention provides a metadata based identifier (ID) interpretation apparatus and method for communication between nodes present in heterogeneous network having different ID systems that may obtain an application layer ID, a network ID, and network information through metadata based ID interpretation in a circumstance where only an application ID of a destination node is known, and thereby may support two-way communication.

According to an aspect of the present invention, there is provided a metadata based identifier (ID) interpretation apparatus for communication between nodes present in heterogeneous networks having different ID systems, the apparatus including: a receiver to receive an application layer ID of a destination node from a transmission node; and a processor to convert, using metadata, network information of the destination node corresponding to the application layer ID, and to transmit the converted network information to the transmission node.

According to another aspect of the present invention, there is provided a metadata based ID interpretation method for communication between nodes present in heterogeneous networks having different ID systems, the method including: receiving an application layer ID of a destination node from a transmission node; and converting, using metadata, network information of the destination node corresponding to the application layer ID, and transmitting the converted network information to the transmission node.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram to describe a communication procedure using metadata based identifier (ID) interpretation according to an embodiment of the present invention;

FIG. 2 is a diagram illustrating a configuration of a metadata based ID interpretation apparatus according to an embodiment of the present invention; and

FIG. 3 is a flowchart illustrating a metadata based ID interpretation method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

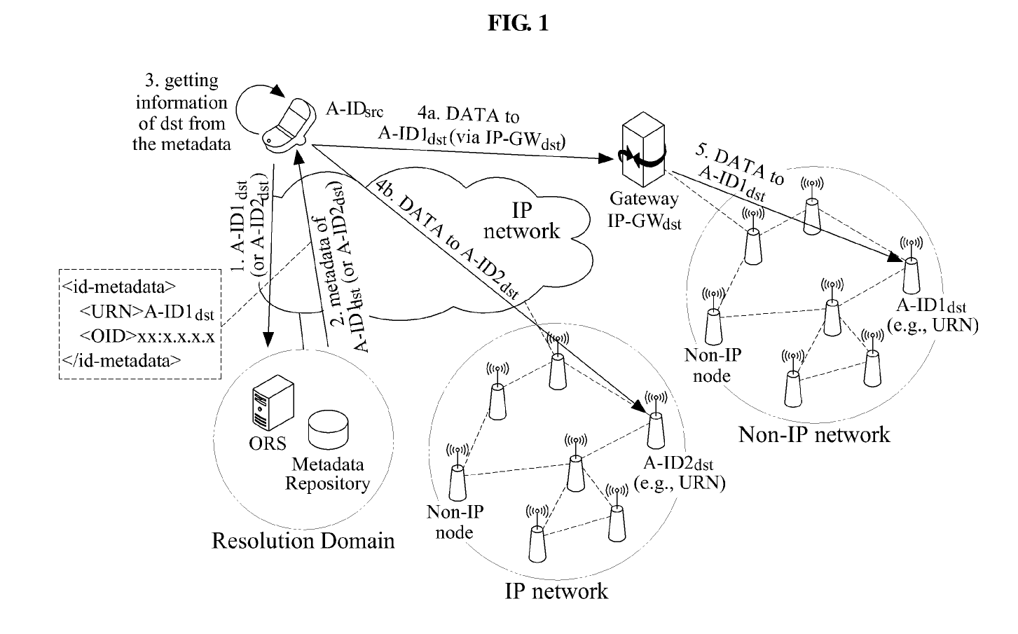

FIG. 1 is a diagram to describe a communication procedure using metadata based identifier (ID) interpretation according to an embodiment of the present invention.

Referring to FIG. 1, nodes present in networks may be divided into two types. First, a node may be connected to an Internet Protocol (IP) access network connected to an IP core network. The node may have an individual application ID and a network ID, for example, a Uniform Resource Name (URN) and an IP address. Second, a node may be connected over a gateway instead of being directly connected to the IP core network, such as a sensor network. The node may have an individual application ID, but may not have a network ID, for example, an IP address.

Also, a domain is present for ID interpretation, and the domain may include a variety of systems for ID interpretation. For example, an interpretation system may include a server for OID(Object IDentifier) interpretation, a metadata storage server, a domain name server, and the like.

Hereinafter, a communication framework using metadata based ID interpretation will be described.

In a network environment of FIG. 1, a transmission node having an application address and A-ID_{src} may perform communication using two different types, for example, one in which a destination node has a shared network address such as an IP address, and the other in which only a gateway has a shared network address and has only a local network connected below.

The transmission node, that is, the transmission node is aware of an application ID address of the destination node, A-ID1_{dst} or A-ID2_{dst}. Here, the application ID address is only one of a large number of ID systems and the transmission node is unaware of an address of a corresponding ID system. In this case, when the transmission node transmits an application address of the destination node to an ID interpretation domain, an in-domain server may receive the application address to obtain, from a metadata repository, information about a type of an ID system, network information of the destination node corresponding to the received application address, and a variety of information required for other communication and to transmit the obtained information. In this case, the transmission node may receive the above information in a metadata form. Metadata may be stored in a tag form such as an extensible markup language (XML). The transmission node may receive, using the metadata, information required for communication corresponding to the application identity address. Through this, the transmission node may be aware of information about the destination node to communicate with, that is, application ID system information of the destination node, a network address system, and an address.

The transmission node receiving the metadata may obtain a destination network address system from the metadata and thereby generate a data packet. Here, since the metadata includes network information of the destination node, the transmission node may verify whether the destination node is a node having a shared network address connected to an IP core network, or a node having a different network address system connected to a gateway.

When the destination node is verified as the node having the shared network address, the transmission node may include a destination address in a destination address of the data packet and thereby transmit the data packet. When the destination node is verified as the node having the different address system, the transmission node may include the destination node in the shared network address of the gateway connected by the destination node and thereby transmit the data packet.

The gateway may receive the data packet. The gateway is aware of a local network address system and thus, may transfer the data packet to a destination network address.

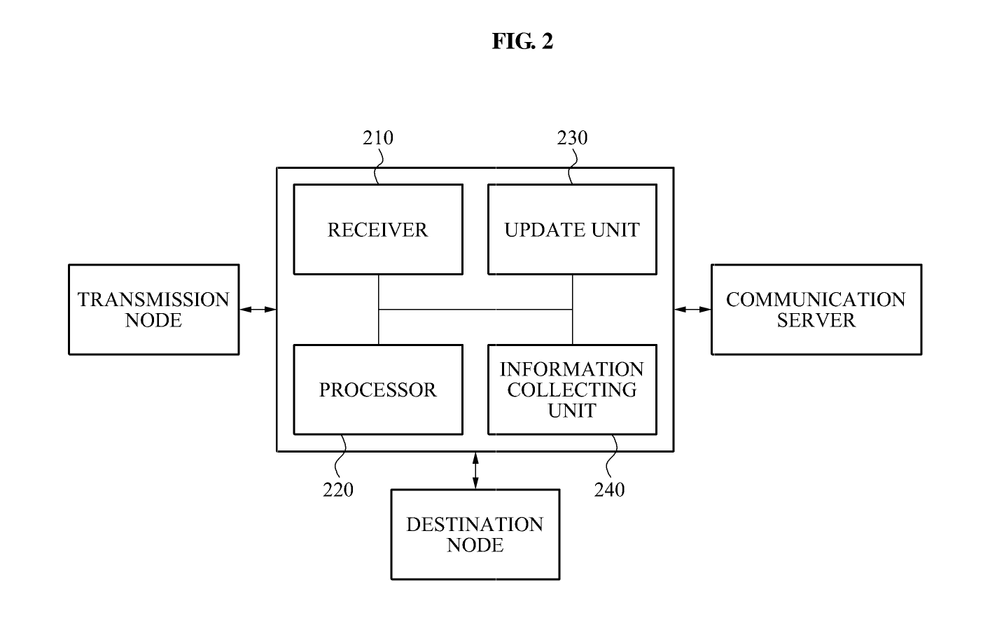

FIG. 2 is a diagram illustrating a configuration of a metadata based ID interpretation apparatus according to an embodiment of the present invention.

Referring to FIG. 2, the metadata based ID interpretation apparatus may include a receiver 210 to receive an application layer ID of a destination node from a transmission node, a processor 220 to convert, using metadata, network information of the destination node corresponding to the application layer ID, and to transmit the converted network information to the transmission node, an update unit 230 to update metadata corresponding to the network information of the second network, and an information collecting unit 240 to collect information included in the metadata in interaction with a communication server.

With only a single ID such as an application layer ID or a network layer ID, the receiver 210 may obtain networking information associated therewith and information associated with a node. For example, when the transmission node transmits the application layer ID of the destination node as an input value, the processor 220 may convert, using metadata, information associated with an IP address of the destination node, a DSN(Data Source Name) address, a URN, a connection port, a relevant service type, for example, a File Transfer Protocol (FTP) server, a web service, and the like, an access network characteristic, whether a corresponding network is a public network, a private network, or a sensor network, and the like, and may transmit the converted information to the transmission node.

The update unit 230 may continuously manage metadata information corresponding to network information of the destination node through a registration and updating procedure.

When the transmission node receives metadata corresponding to the given application ID, and when a corresponding network employs TCP/IP, the transmission node may encode a data packet to be suitable for a corresponding protocol form and thereby transmit the data packet. When the corresponding network employs a different protocol, for example, ZigBee, the transmission node may encode the data packet to be suitable for a corresponding protocol form and thereby transmit the data packet.

The processor 220 may receive an application ID as a key and thereby transmit information associated with metadata. Information included in the metadata may be collected in interaction with relevant servers. For example, among information of a node utilizing the application ID, the information collecting unit 240 may obtain an IP address through direct communication with the destination node. Also, the information collecting unit 240 may obtain a Media Access Control (MAC) address through communication with an Address Resolution Protocol (ARP) proxy server that stores corresponding information, and may obtain a DNS address through a DNS server. As described above, a management process such as cyclically registering and updating information may be frequently performed within an interpretation apparatus

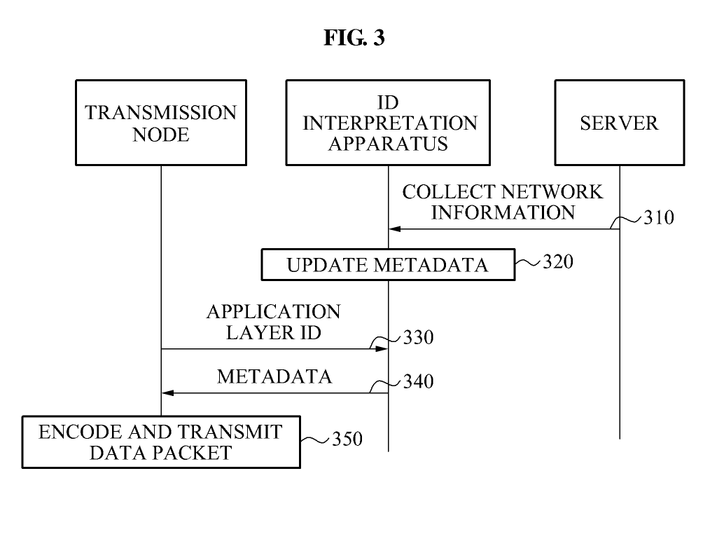

FIG. 3 is a flowchart illustrating a metadata based ID interpretation method according to an embodiment of the present invention.

In operation 310, an ID interpretation apparatus may collect network information included in metadata in interaction with a corresponding sever, and may store the collected network information in a database. Among node information of a node utilizing an application ID, the ID interpretation apparatus may obtain an IP address through direct communication with a destination node. Also, the ID interpretation apparatus may obtain a MAC address through communication with an ARP proxy server that stores corresponding information, and may obtain a DNS address through a DNS server. As described above, information is cyclically registered and updated within the interpretation apparatus.

In operation 320, the ID interpretation apparatus may update metadata corresponding to the network information in a database by searching for a destination node. The ID interpretation apparatus may continuously manage metadata information corresponding to the network information of the destination node through a registration and updating procedure.

In operation 330, the ID interpretation apparatus may receive an application layer ID of the destination node from the transmission node. With only a single ID such as the application layer ID or a network layer ID, the ID interpretation apparatus may obtain networking information associated therewith and information associated with a node.

In operation 340, the ID interpretation apparatus may convert, using metadata, network information of the destination node corresponding to the application layer ID, and may transmit the converted information to the transmission node.

In operation 350, the transmission node may encode and thereby transmit a data packet to be suitable for a protocol form based on the network information by referring to the metadata. When the transmission node receives metadata corresponding to the given application ID, and when a corresponding network employs a TCP/IP, the transmission node may encode a data packet to be suitable for a corresponding protocol form and thereby transmit the data packet. When the corresponding network utilizes a different protocol, for example, ZigBee, the transmission node may encode the data packet to be suitable for a corresponding protocol form and thereby transmit the data packet.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to embodiments of the present invention, communication between nodes having different identity systems may be performed by integrally managing all of the IDs using an application layer ID and through ID interaction.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A metadata based identifier (ID) interpretation apparatus for communication between nodes present in heterogeneous networks having different ID systems, the apparatus comprising:
a receiver to receive an application layer ID of a destination node from a transmission node; and
a processor to convert, using metadata, network information of the destination node corresponding to the application layer ID, and to transmit the converted network information to the transmission node.

2. The apparatus of claim 1, wherein the processor comprises:
an update unit to update metadata corresponding to the network information by searching for the destination node.

3. The apparatus of claim 1, wherein the transmission node encodes and thereby transmits a data packet to be suitable for a protocol form based on the network information by referring to the metadata.

4. The apparatus of claim 1, wherein the processor comprises:
an information collecting unit to collect the network information included in the metadata in interaction with a corresponding server.

5. A metadata based identifier (ID) interpretation method for communication between nodes present in heterogeneous networks having different ID systems, the method comprising:
receiving an application layer ID of a destination node from a transmission node; and
converting, using metadata, network information of the destination node corresponding to the application layer ID, and transmitting the converted network information to the transmission node.

6. The method of claim 5, wherein the converting comprises:
updating metadata corresponding to the network information by searching for the destination node.

7. The method of claim 5, wherein the transmission node encodes and thereby transmits a data packet to be suitable for a protocol form based on the network information by referring to the metadata.

8. The method of claim 5, wherein the converting comprises:
collecting the network information included in the metadata in interaction with a corresponding server.
